(19) United States
(12) Patent Application Publication
(10) Pub. No.: US 2022/0201430 A1
(43) Pub. Date: Jun. 23, 2022

(54) ELECTRONIC DEVICE AND METHOD FOR WIRELESS COMMUNICATION, AND COMPUTER READABLE STORAGE MEDIUM

(71) Applicant: Sony Group Corporation, Tokyo (JP)

(72) Inventors: Bin SHENG, Jiangsu (CN); Pingping XU, Jiangsu (CN); Chen SUN, Beijing (CN)

(73) Assignee: Sony Group Corporation, Tokyo (JP)

(21) Appl. No.: 17/604,443

(22) PCT Filed: May 25, 2020
(86) PCT No.: PCT/CN2020/092007

§ 371 Date: Oct. 18, 2021

(30) Foreign Application Priority Data
May 30, 2019 (CN) 2019 10462858.2

(51) Int. Cl. H04W 4/02; G01S 5/02; G01S 5/04; G01S 5/06; H04W 64/00

(52) U.S. Cl. CPC H04W 4/023; G01S 5/0257; H04W 64/006; G01S 5/06; G01S 5/04

(57) ABSTRACT

The present application provides an electronic device and method for wireless communication, and a computer readable storage medium. The electronic device comprises a processing circuit, configured to: obtain beam related information of at least a first beam and a second beam estimated by a target user equipment, the beam related information comprising an angle of arrival of the beam and information for distance estimation; and determine the position of the target user equipment at least on the basis of the beam related information of the first beam and the second beam as well as an emission angle of the first beam and an emission angle of the second beam.

The present application claims priority to Chinese Patent Application No. 201910462858.2, titled “ELECTRONIC DEVICE AND METHOD FOR WIRELESS COMMUNICATION, AND COMPUTER READABLE STORAGE MEDIUM”, filed on May 30, 2019 with the China National Intellectual Property Administration (CNIPA), which is incorporated herein by reference in its entirety.

### FIELD

The present disclosure relates to the technical field of wireless communications, in particular to a positioning technology based on wireless communications, and more in particular to an electronic apparatus and a method for wireless communications, and a computer-readable storage medium.

### BACKGROUND

Position information is important data in various application scenarios. Existing positioning methods mainly include a multilateration method and a cooperative location method. In the multilateration method, a receiving end measures signals transmitted by multiple transmitting ends. These transmitting ends know their respective positions. The receiving end determines its own position based on a geometric method. Multilateration techniques include, for example, observed time difference of arrival (OTDOA), angle of arrival plus time advance (AOA+TA), etc. In the OTDOA, a base station transmits pilot signals for positioning to a user terminal through a downlink channel. The user terminal measures a time difference between time instants at which these pilot signals from the base stations arrive at the user terminal, to estimate a position of the user terminal. In the AOA+TA, the base station estimates a position of the user terminal by measuring the AOA and time of arrival of an uplink signal. The cooperative location method is mostly used in wireless sensor networks. In the various existing location methods, whether in the multilateration method or in the cooperative location method, it is assumed that there is a line of sight (LOS, which means that a wireless signal is transmitted in a straight line between a transmitting end and a receiving end without being blocked) path between the transmitting end and the receiving end, and when it operations in a propagation environment without a LoS path, the positioning accuracy is greatly reduced.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

According to an aspect of the present disclosure, an electronic apparatus for wireless communications is provided. The electronic apparatus includes processing circuitry. The processing circuitry is configured to: acquire beam related information of at least a first beam and a second beam estimated by a target user device, the beam related information including an angle of arrival of a beam and information for distance estimation; and determine, at least based on the beam related information of the first beam and the second beam as well as an angle of departure of the first beam and an angle of departure of the second beam, a position of the target user device.

According to an aspect of the present disclosure, a method for wireless communications is provided. The method includes: acquiring beam related information of at least a first beam and a second beam estimated by a target user device, the beam related information including an angle of arrival of a beam and information for distance estimation; and determining, at least based on the beam related information of the first beam and the second beam as well as an angle of departure of the first beam and an angle of departure of the second beam, a position of the target user device.

According to another aspect of the present disclosure, an electronic apparatus for wireless communications is provided. The electronic apparatus includes processing circuitry. The processing circuitry is configured to: estimate beam related information of at least a first beam and a second beam which are received, the beam related information including an angle of arrival of a beam and information for distance estimation; acquire information of angles of departure of at least the first beam and the second beam; and determine, at least based on the beam related information of the first beam and the second beam as well as information of an angle of departure of the first beam and an angle of departure of the second beam, a position of the electronic apparatus.

According to another aspect of the present disclosure, a method for wireless communications is provided. The method includes: estimating beam related information of at least a first beam and a second beam which are received, the beam related information including an angle of arrival of a beam and information for distance estimation; acquiring information of angles of departure of at least the first beam and the second beam; and determining, at least based on the beam related information of the first beam and the second beam as well as information of an angle of departure of the first beam and an angle of departure of the second beam, a position of an electronic apparatus.

According to other aspects of the present disclosure, there are further provided computer program codes and computer program products for implementing the methods for wireless communications above, and a computer readable storage medium having recorded thereon the computer program codes for implementing the methods for wireless communications described above.

With the electronic apparatus and the method according to the present disclosure, the position of the target user device is determined by using at least two beams, so that the position of the target user device is determined accurately in both cases of presence and absence of an LOS path.

These and other advantages of the present disclosure will be more apparent by illustrating in detail a preferred embodiment of the present disclosure in conjunction with accompanying drawings below.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure. In the accompanying drawings:

FIG. 1 shows an example of a scenario with a Not Line of Sight (NLOS) path between a transmitting end and a receiving end;

FIG. 2 is a functional block diagram showing an electronic apparatus for wireless communications according to an embodiment of the present disclosure;

FIG. 3 is a schematic diagram showing a definition of AOA of a user device;

FIG. 4 is a schematic diagram showing positioning of a target user device with the technology of this embodiment in the scenario shown in FIG. 1;

FIG. 5 is a schematic diagram showing positioning of a vehicle in a case of a value range of an AOA and a value range of an angle of departure (AOD);

FIG. 6 is a schematic diagram showing positioning of a vehicle in another case of a value range of the AOA and a value range of the AOD;

FIG. 7 is a schematic diagram showing positioning of a vehicle in another case of a value range of the AOA and a value range of the AOD;

FIG. 8 is a schematic diagram showing positioning of a vehicle in another case of a value range of the AOA and a value range of the AOD;

FIG. 9 is a schematic diagram showing positioning of a vehicle in another case of a value range of the AOA and a value range of the AOD;

FIG. 10 is a schematic diagram showing positioning of a vehicle in another case of a value range of the AOA and a value range of the AOD;

FIG. 11 is a schematic diagram showing positioning of a vehicle in another case of a value range of the AOA and a value range of the AOD;

FIG. 12 is a schematic diagram showing positioning of a vehicle in another case of a value range of the AOA and a value range of the AOD;

FIG. 13 is a functional block diagram showing an electronic apparatus for wireless communications according to an embodiment of the present disclosure;

FIG. 14 shows an example of wide beam scanning;

FIG. 15 is a schematic diagram showing processing when a vehicle is detected in a predetermined region;

FIG. 16 is a schematic diagram showing a relationship between a moving direction of the vehicle and an emission direction of a narrow beam;

FIG. 17 is a schematic diagram showing an information procedure between a road side unit and the vehicle in a positioning process according to this embodiment;

FIG. 18 is a functional block diagram showing an electronic apparatus for wireless communications according to another embodiment of the present disclosure;

FIG. 19 is a flowchart showing a method for wireless communications according to an embodiment of the present disclosure;

FIG. 20 is a flowchart showing a method for wireless communications according to another embodiment of the present disclosure;

FIG. 21 is a block diagram showing a first example of a schematic configuration of an eNB or a gNB to which the technology according to the present disclosure may be applied;

FIG. 22 is a block diagram showing a second example of a schematic configuration of an eNB or a gNB to which the technology according to the present disclosure may be applied;

FIG. 23 is a block diagram showing an example of a schematic configuration of a smartphone to which the technology according to the present disclosure may be applied;

FIG. 24 is a block diagram showing an example of a schematic configuration of a car navigation apparatus to which the technology according to the present disclosure may be applied; and

FIG. 25 is a block diagram of an exemplary block diagram illustrating the structure of a general purpose personal computer capable of realizing the method and/or device and/or system according to the embodiments of the present disclosure.

### DETAILED DESCRIPTION OF EMBODIMENTS

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a business, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

### First Embodiment

As described above, in the existing positioning technology, the positioning accuracy is reduced in a case of there being no LOS path between a transmitting end and a receiving end, that is, in a case that a wireless signal is transmitted via a not line of sight (NLOS) path from the transmitting end to the receiving end. The AOA+TA method is taken as an example. FIG. 1 shows an example of a scenario with a NLOS path between a transmitting end and a receiving end. FIG. 1 shows a V2X scenario. The transmitting end is a road side unit (RSU), and the receiving end is a vehicle at the top of the picture. It can be seen that due to the existence of a blockage, an uplink signal transmitted by a target vehicle is scattered by another vehicle before arriving at the RSU. An AOA of the uplink signal received by the RSU cannot reflect an actual position of the target vehicle relative to the RSU. Therefore, a position of the target vehicle calculated based on the AOA and TA is wrong, and has a deviation before the actual position.

In order to solve this problem, a solution for positioning a target user device based on at least two beams is provided according to this embodiment. With the solution according to the embodiment, the position of the target user device can be determined accurately in no matter where there is a LOS path.

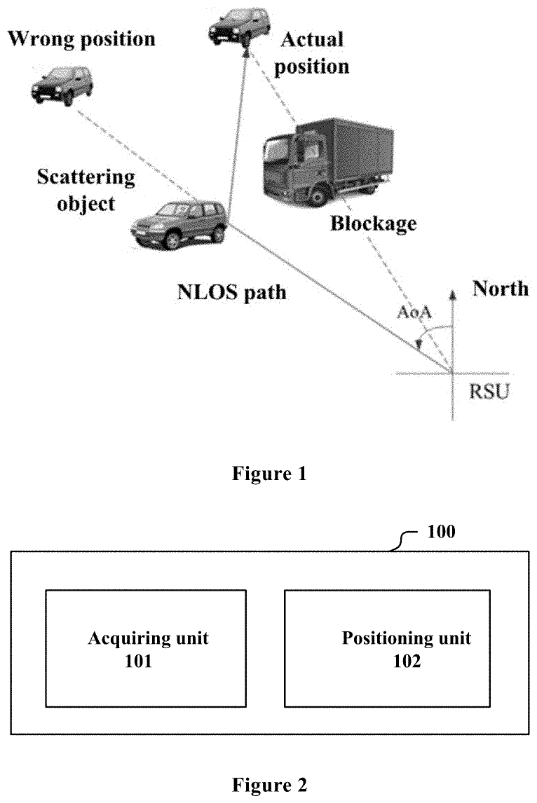

FIG. 2 is a functional block diagram showing an electronic apparatus 100 for wireless communications according to this embodiment. As shown in FIG. 2, the electronic apparatus 100 includes an acquiring unit 101 and a positioning unit 102. The acquiring unit 101 is configured to acquire beam related information of at least a first beam and a second beam estimated by a target user device. The beam related information includes an angle of arrival (AOA) of a beam and information for distance estimation. The positioning unit 102 is configured to determine, at least based on the beam related information of the first beam and the second beam as well as an angle of departure (AOD) of the first beam and an angle of departure of the second beam, a position of the target user device.

The acquiring unit 101 and the positioning unit 102 may be implemented by one or more processing circuits, which may be implemented as a chip or processor, for example. In addition, it should be understood that functional units in the electronic apparatus shown in FIG. 2 are only logical modules divided based on their respective functions, and are not intended to limit a specific implementation manner, which is also applicable to examples of other apparatus to be described later.

The electronic apparatus 100 may be provided on a side of the base station or communicatively connected to the base station, for example. In a V2X scenario, the electronic apparatus 100 may also be provided on a side of an RSU. More generally, the electronic apparatus 100 may be provided on any transmitting end whose position is known. In addition, the electronic apparatus 100 may also be arranged on any server functioning as a positioning server.

Here, it should further be noted that the electronic apparatus 100 may be implemented at a chip level, or a device level. For example, the electronic apparatus 100 may function as a base station or an RSU itself, and further include an external device such as a memory, a transceiver (not shown in the drawings), and the like. The memory is configured to store programs executed by the base station or the RSU to implement various functions and related data information. The transceiver may include one or more communication interfaces to support communication with various devices (for example, a base station, a user device, other RSU or the like). An implementation form of the transceiver is not limited herein.

The target user device described in this embodiment may be, for example, any terminal device that needs to know its own position, such as a vehicle or a mobile communication terminal.

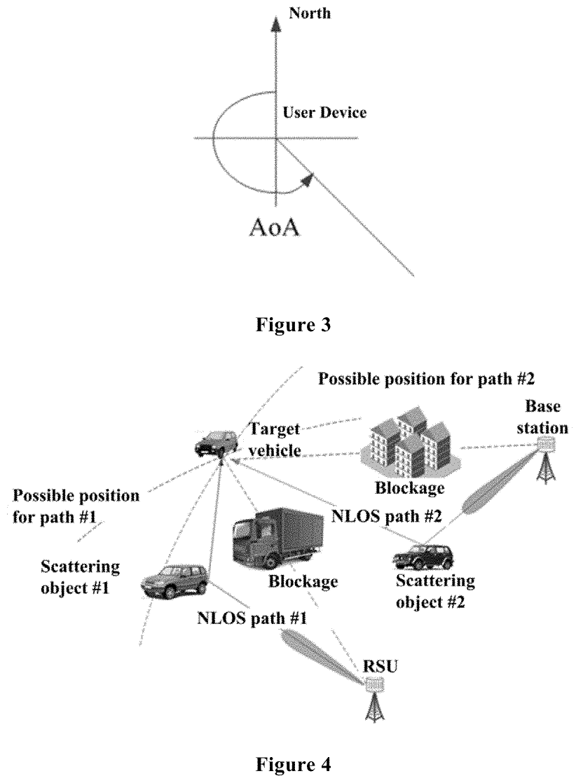

The base station or the RSU serving as the transmitting end transmits a beam to the target user device. The beam has a certain angle of departure AOD. The AOD is defined relative to a reference direction of the transmitting end (for example, the true north direction), for example. The target user device serving as the receiving end adopts, for example, massive multiple-input multiple-output (Massive MIMO) antenna technology as well, so as to be capable of estimating an AOA of the signal after receiving the beam. A definition of the AOA on the side of a user device is shown in FIG. 3. The AOA is expressed by an angle of a direction of arrival of the beam relative to a predetermined reference direction. The predetermined reference direction is the true north direction at a geographic position of the user device. The angle of counterclockwise rotation is positive, and clockwise rotation is negative. The AOA ranges from 0 to 360 degrees, and has a certain resolution, for example, 0.5 degree. It should be understood that the definition of the reference direction and the resolution of the angle are not limited thereto. The target user device may estimate the AOA in various manners. For example, the target user device generates a receiving beam and estimates the AOA based on an angle between a direction of the receiving beam and the reference direction. Alternatively, the target user device estimates the AOA in a super-resolution manner such as multiple signal classification (MUSIC) method instead of generating a receiving beam.

In addition, the target user device may further acquire information for distance estimation, and provides the information for distance estimation together with the AOA to the electronic apparatus 100.

The information for distance estimation includes information of time of arrival of the beam, such as time advance (TA). The positioning unit 102 estimates a travelling distance of the first beam from the transmitting end of the first beam to the target user device based on information of time of arrival of the first beam, and estimates a travelling distance of the second beam from the transmitting end of the second beam to the target user device based on information of time of arrival of the second beam. Specifically, a difference between the time of departure of a beam and the time of arrival of the beam is travelling duration of the wireless signal in the air. The difference being multiplied by a propagation speed of the wireless signal may lead to a travelling distance of the beam from the transmitting end to the target user device.

Alternatively, the information for distance estimation may include information of received power of a beam. The positioning unit 102 estimates a travelling distance of the first beam from the transmitting end of the first beam to the target user device based on information of the received power of the first beam, and estimates a travelling distance of the second beam from the transmitting end of the second beam to the target user device based on information of the received power of the second beam. Specifically, the positioning unit 102 may calculate a travelling distance of a beam from the transmitting end to the target user device based on a path loss coefficient and a difference between transmission power and received power of the beam. Correspondingly, the acquiring unit 102 acquires information of the transmission power and the path loss coefficient from the corresponding transmitting end.

In this embodiment, the target user device receives at least two beams and provides at least two sets of such information. For example, in a case that the target user device receives more than two beams, the acquiring unit 101 may further select two of these beams as the first beam and the second beam to acquire and provide the foregoing information. Illustratively, the acquiring unit 101 may select two beams with better beam quality. Alternatively, the acquiring unit 101 may acquire the aforementioned beam related information of more than two beams.

In addition, the acquiring unit 102 further acquires information of an angle of departure AOD of the corresponding beam from each transmitting end.

For example, the first beam is transmitted by a first RSU or a first base station, and the second beam is transmitted by a second RSU or a second base station. In a case that the electronic apparatus 100 is located on a positioning server, the acquiring unit 102 acquires the AOD of the first beam from the first RSU or the first base station, and acquires the AOD of the second beam from the second RSU or the second base station. In a case that the electronic apparatus 100 is located on a side of the first RSU or the first base station, the acquiring unit 102 only needs to acquire the AOD of the second beam from the second RSU or the second base station.

The acquiring unit 101 may acquire the aforementioned beam related information through communication on a low frequency band, such as the FR1 (Frequency Range 1) frequency band (which is a frequency band below 6 GHz) in 5G communication, without forming a beam. Alternatively, the acquiring unit 101 may also acquire the above-mentioned beam related information through communication on a high frequency band, such as the FR2 (Frequency Range 2) frequency band (which is a frequency band above 6 GHz) in 5G communication. In this case, the target user device may form a transmission beam based on a direction of the AOA.

In an example, the positioning unit 102 determines the position of the target user device based on a geometric relationship between actual propagation paths of the first beam and the second beam and a spatial position of the target user device. For example, the positioning unit 102 may calculate the position of the target user device using a set of equations with position parameters of the target user device as the unknowns. In other words, the positioning unit 102 determines the position of the target user device based on an analytical algorithm.

FIG. 4 is a schematic diagram showing positioning of a target user device with the technology of this embodiment in the scenario shown in FIG. 1. The first beam is transmitted by the RSU, and the second beam is transmitted by the base station. The first beam arrives at a target vehicle (that is, the target user device) via an NLOS path #1. The second beam arrives at the target vehicle (that is, the target user device) via an NLOS path #2. The target vehicle provides the acquired AOA and information of time of arrival of the first beam to the electronic apparatus 100. In this example, it is assumed that the electronic apparatus 100 is located on the base station. However, it should be understood that this is not restrictive, and the electronic apparatus 100 may be located on the RSU or on a dedicated server. The schematic diagram shown in FIG. 4 is only an example and is not restrictive, and the target user device is not limited to the vehicle shown in the FIG. 4.

In plane coordinates, the position of the vehicle is represented by coordinates (x, y). That is, position information of the vehicle includes two unknowns. Therefore, two sets of parameters of the two beams are required to obtain two equations so as to get the solution. These two equations are generated in a same manner. Generation of one equation is described below by taking one beam as an example (for example, the beam transmitted by the RSU in FIG. 4). A set of parameters corresponding to the beam includes the AOA and AOD of the beam, and a travelling distance of the beam from the transmitting end to the target vehicle. The travelling distance is a length of the NLOS path #1.

All situations are divided into 8 cases based on ranges of the AOA and the AOD. It is assumed that in an x-y plane, coordinates of the RSU are (0, 0), and d represents the length of the NLOS path #1 between the RSU and the vehicle, Or represents an AOA, and Or represents an AOD.

$$\underline{\text{Case 1:}} π \leq {θ}_{t} < \frac{3 π}{2} , 0 \leq {θ}_{r} < \frac{π}{2}$$

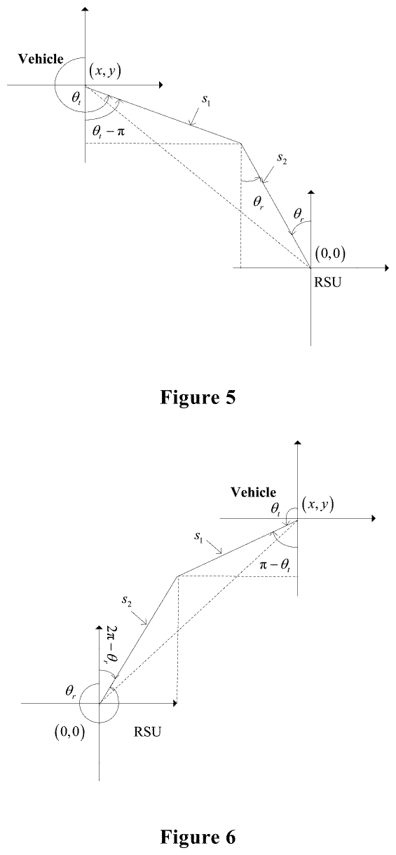

FIG. 5 is a schematic diagram showing positioning of a vehicle in the case 1. s₂ represents a length of a first part of the NLOS path #1 before the beam is scatted at a scattering object #1. s₁ represents a length of a second part of the NLOS path #1 after the beam is scattered at the scattering object #1. Meanings of s₂ and s₁ in the following FIGS. 6 to 12 are similar to those in FIG. 5, and therefore are not repeated. The following equations (2) to (4) are acquired from FIG. 5.

s₁ sin(θₜ−π)+s₂ sin θᵣ=−x (2)

s₁ cos(θₜ−π)+s₂ cos θᵣ=y (3)

s₁+s₂=d (4)

s₂=d−s₁ is substituted into the equations (2) and (3), to obtain the following equations (5) and (6).

s₁ sin(θₜ−π)+(d−s₁)sin θᵣ=−x (5)

s₁ cos(θₜ−π)+(d−s₁)cos θᵣ=y (6)

The equation (6) is further written as the following equation (7).

$${s}_{1} = \frac{d cos {θ}_{r} - y}{cos {θ}_{t} + cos {θ}_{r}} \qquad ( 7 )$$

The equation (7) is substituted into the equation (5) to obtain the following equation (8).

(sin θₜ+sin θᵣ)y+(cos θₜ+cos θᵣ)x=d sin(θₜ−θᵣ) (8)

The equation (8) is the equation obtained in the case 1 with the position parameters x and y of the vehicle as unknowns. θₜ, θᵣ and d are all known.

$$Case 2 \text{:} \frac{π}{2} \leq {θ}_{t} < π , \frac{3 π}{2} \leq {θ}_{r} < 2 π$$

FIG. 6 is a schematic diagram showing positioning of a vehicle in the case 2. The following equations (9) to (11) can be acquired from FIG. 6.

s₁ sin(π−θₜ)+s₂ sin(2π−θᵣ)=x (9)

s₁ cos(π−θₜ)+s₂ cos(2π−θᵣ)=y (10)

s₁+s₂=d (11)

s₂=d−s₁ is substituted into the equations (9) and (10), to obtain the following equations (12) and (13).

s₁ sin(π−θₜ)+(d−s₁)sin(2π−θᵣ)=x (12)

s₁ cos(π−θₜ)+(d−s₁)cos(2π−θᵣ)=y (13)

The equation (13) is further written as the following equation (14).

$${s}_{1} = \frac{d cos {θ}_{r} - y}{cos {θ}_{t} + cos {θ}_{r}} \qquad ( 14 )$$

The equation (13) is substituted into the equation (12) to obtain the following equation (15).

(sin θₜ+sin θᵣ)y+(cos θₜ+cos θᵣ)x=d sin(θₜ−θᵣ) (15)

The equation (15) is the equation obtained in the case 2 with the position parameters x and y of the vehicle as unknowns. θₜ, θᵣ and d are all known.

$$Case 3 \text{:} π \leq {θ}_{t} < \frac{3 π}{2} , \frac{3 π}{2} \leq {θ}_{r} < 2 π$$

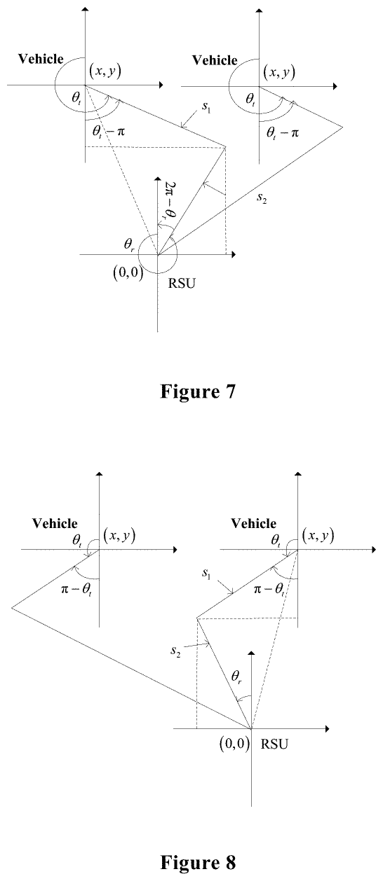

FIG. 7 is a schematic diagram showing positioning of a vehicle in the case 3. Two scenarios are shown according to positions of the vehicle in the x-axis direction. The following equations (16) to (18) can be acquired from FIG. 7.

s₁ sin(θₜ−π)−s₂ sin(2π−θᵣ)=−x (16)

s₁ cos(θₜ−π)+s₂ cos(2π−θᵣ)=y (17)

s₁+s₂=d (18)

s₂=d−s₁ is substituted into the equations (16) and (17), to obtain the following equations (19) and (20).

s₁ sin(θₜ−x)−(d−s₁)sin(2π−θᵣ)=−x (19)

s₁ cos(θᵣ−π)+(d−s₁)cos(2π−θᵣ)=y (20)

The equation (20) is further written as the following equation (21).

$${s}_{1} = \frac{d cos {θ}_{r} - y}{cos {θ}_{t} + cos {θ}_{r}} \qquad ( 21 )$$

The equation (21) is substituted into the equation (19) to obtain the following equation (22).

(sin θₜ+sin θᵣ)y+(cos θₜ+cos θᵣ)x=d sin(θₜ−θᵣ) (22)

The equation (22) is the equation obtained in the case 3 with the position parameters x and y of the vehicle as unknowns. θₜ, θᵣ and d are all known.

$$Case 4 \text{:} \frac{π}{2} \leq {θ}_{t} < π , 0 \leq {θ}_{r} < \frac{π}{2}$$

FIG. 8 is a schematic diagram showing positioning of a vehicle in the case 4. Two scenarios are shown according to positions of the vehicle in the x-axis direction. The following equations (23) to (25) can be acquired from FIG. 8.

s₁ sin(π−θₜ)−s₂ sin θᵣ=x (23)

s₁ cos(π−θₜ)+s₂ cos θᵣ=y (24)

s₁+s₂=d (25)

s₂=d−s₁ is substituted into the equations (23) and (24), to obtain the following equations (26) and (27).

s₁ sin(π−θₜ)−(d−s₁)sin θᵣ=x (26)

s₁ cos(π−θₜ)+(d−s₁)cos θᵣ=y (27)

The equation (27) is further written as the following equation (28).

$${s}_{1} = \frac{d cos {θ}_{r} - y}{cos {θ}_{t} + cos {θ}_{r}} \qquad ( 28 )$$

The equation (28) is substituted into the equation (26) to obtain the following equation (29).

(sin θₜ+sin θᵣ)y+(cos θₜ+cos θᵣ)x=d sin(θₜ−θᵣ) (29)

The equation (29) is the equation obtained in the case 4 with the position parameters x and y of the vehicle as unknowns. θₜ, θᵣ and d are all known.

$$Case 5 \text{:} 0 \leq {θ}_{t} < \frac{π}{2} , 0 \leq {θ}_{r} < \frac{π}{2}$$

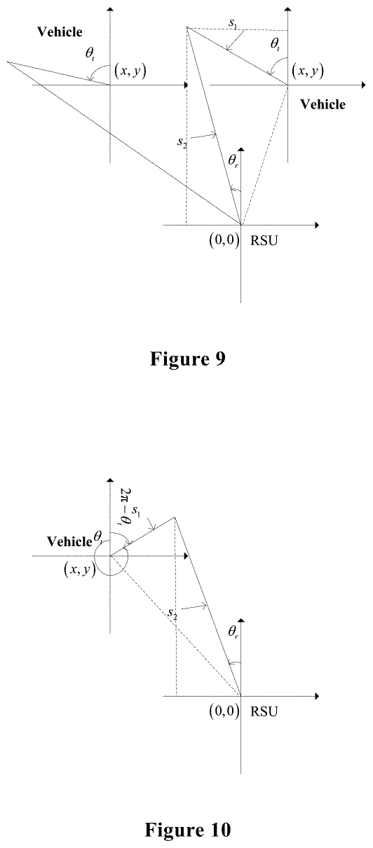

FIG. 9 is a schematic diagram showing positioning of a vehicle in the case 5. Two scenarios are shown according to positions of the vehicle in the x-axis direction. The following equations (30) to (32) can be acquired from FIG. 9.

s₁ sin θₜ−s₂ sin θᵣ=x (30)

s₁ cos θₜ−s₂ cos θₜ=−y (31)

s₁+s₂=d (32)

s₂=d−s₁ is substituted into the equations (30) and (31), to obtain the following equations (33) and (34).

s₁ sin θₜ−(d−s₁)sin θᵣ=x (33)

s₁ cos θₜ−(d−s₁)cos θᵣ=−y (34)

The equation (34) is further written as the following equation (35).

$${s}_{1} = \frac{d cos {θ}_{r} - y}{cos {θ}_{t} + cos {θ}_{r}} \qquad ( 35 )$$

The equation (35) is substituted into the equation (33) to obtain the following equation (36).

(sin θₜ+sin θᵣ)y+(cos θₜ+cos θᵣ)x=d sin(θₜ−θᵣ) (36)

The equation (36) is the equation obtained in the case 5 with the position parameters x and y of the vehicle as unknowns. θₜ, θᵣ and d are all known.

$$Case 6 \text{:} \frac{3 π}{2} \leq {θ}_{t} < 2 π , 0 \leq {θ}_{r} < \frac{π}{2}$$

FIG. 10 is a schematic diagram showing positioning of a vehicle in the case 6. The following equations (37) to (39) can be acquired from FIG. 10.

s₁ sin(2π−θₜ)+s₂ sin θᵣ=−x (37)

s₁ cos(2π−θᵣ)−s₂ cos θᵣ=−y (38)

s₁+s₂=d (39)

s₂=d−s₁ is substituted into the equations (37) and (38), to obtain the following equations (40) and (41).

s₁ sin(2π−θₜ)+(d−s₁)sin θᵣ=−x (40)

s₁ cos(2π−θₜ)−(d−s₁)cos θᵣ=−y (41)

The equation (41) is further written as the following equation (42).

$${s}_{1} = \frac{d cos {θ}_{r} - y}{cos {θ}_{t} + cos {θ}_{r}} \qquad ( 42 )$$

The equation (42) is substituted into the equation (40) to obtain the following equation (43).

(sin θₜ+sin θᵣ)y+(cos θₜ+cos θᵣ)x=d sin(θₜ−θᵣ) (43)

The equation (43) is the equation obtained in the case 6 with the position parameters x and y of the vehicle as unknowns. θₜ, θᵣ and d are all known.

$$Case 7 \text{:} \frac{3 π}{2} \leq {θ}_{t} < 2 π , \frac{3 π}{2} \leq {θ}_{r} < 2 π$$

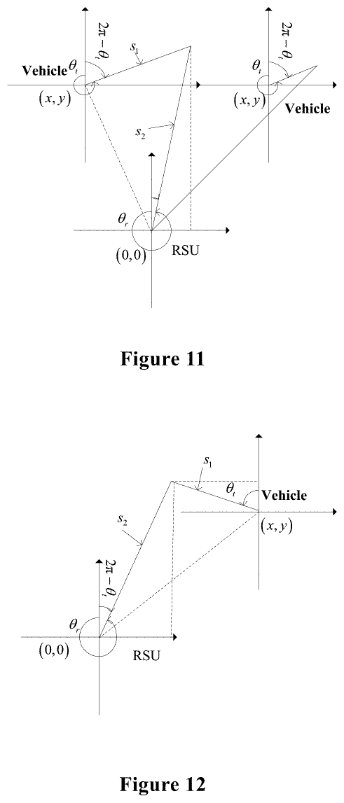

FIG. 11 is a schematic diagram showing positioning of a vehicle in the case 7. Two scenarios are shown according to positions of the vehicle in the x-axis direction. The following equations (44) to (46) are acquired from FIG. 11.

s₁ sin(2π−θₜ)−s₂ sin(2π−θᵣ)=−x (44)

s₁ cos(2π−θₜ)−s₂ cos(2π−θᵣ)=−y (45)

s₁+s₂=d (46)

s₂=d−s₁ is substituted into the equations (44) and (45), to obtain the following equations (47) and (48).

s₁ sin(2π−θₜ)−(d−s₁)sin(2π−θᵣ)=−x (47)

s₁ cos(2π−θₜ)−(d−s₁)cos(2π−θᵣ)=−y (48)

The equation (48) is further written as the following equation (49).

$${s}_{1} = \frac{d cos {θ}_{r} - y}{cos {θ}_{t} + cos {θ}_{r}} \qquad ( 49 )$$

The equation (49) is substituted into the equation (47) to obtain the following equation (50).

(sin θₜ+sin θᵣ)y+(cos θᵣ+cos θₜ)x=d sin(θₜ−θᵣ) (50)

The equation (50) is the equation obtained in the case 7 with the position parameters x and y of the vehicle as unknowns. θₜ, θᵣ and d are all known.

$$Case 8 \text{:} 0 \leq {θ}_{t} < \frac{π}{2} , \frac{3 π}{2} \leq {θ}_{r} < 2 π$$

FIG. 12 is a schematic diagram showing positioning of a vehicle in the case 8. The following equations (51) to (53) can be acquired from FIG. 12.

s₁ sin θₜ+s₂ sin(2π−θᵣ)=x (51)

s₁ cos θₜ−s₂ cos(2π−θᵣ)=−y (52)

s₁+s₂=d (53)

s₂=d−s₁ is substituted into the equations (51) and (52), to obtain the following equations (54) and (55).

s₁ sin θₜ+(d−s₁)sin(2π−θᵣ)=x (54)

s₁ cos θₜ−(d−s₁)cos(2π−θᵣ)=−y (55)

The equation (55) is further written as the following equation (56).

$${s}_{1} = \frac{d cos {θ}_{r} - y}{cos {θ}_{t} + cos {θ}_{r}} \qquad ( 56 )$$

The equation (56) is substituted into the equation (54) to obtain the following equation (57).

(sin θₜ+sin θᵣ)y+(cos θₜ+cos θᵣ)x=d sin(θₜ−θᵣ) (57)

The equation (57) is the equation obtained in the case 8 with the position parameters x and y of the vehicle as unknowns. θₜ, θᵣ and d are all known.

It can be seen form the above analysis that the coordinate equation of the vehicle has the same form in all cases. Returning to the example in FIG. 4, it is assumed that the length of NLOS path #1, the AOA and the AOD are d₁, θₜ₁, θᵣ₁, respectively; and the length of NLOS path #2, the AOA and the AOD are d₂, θₜ₂, θᵣ₂, respectively. The following two equations (58) to (59) are acquired from the above analysis.

(sin θₜ₁+sin θᵣ₁)y+(cos θₜ₁+cos θₜ₁)x=d₁ sin(θₜ₁−θᵣ₁) (58)

(sin θₜ₂+sin θᵣ₂)y+(cos θₜ₂+cos θᵣ₂)x=d₂ sin(θₜ₂−θᵣ₂) (59)

The coordinates (x, y) of the vehicle are calculated by considering the two equations. It should be understood that although the NLOS path is taken as an example for description above, the obtained equations (58) and (59) is also applicable to the case of LOS path without distinction.

In the above example, the position of the target user device is expressed in plane coordinates. The position of the target user device can also be expressed in polar coordinates. In addition, the position of the target user device may also be expressed in absolute position coordinates (for example, longitude and latitude), or expressed in relative position coordinates relative to a predetermined reference object.

In another example, the positioning unit 102 may determine the position of the target user device using a minimum mean square error (MMSE) algorithm. For example, in a case that the target user device receives more than two beams and estimates more than two sets of parameters, the positioning unit 102 may adopts advanced signal processing techniques such as the MMSE algorithm to estimate the position parameters of the target user device based on these parameters.

In summary, the electronic apparatus 100 according to this embodiment can position the target user device based on at least two beams, and can accurately determine the position of the target user device in both cases of the presence and absence of an LOS path. The set of equations is solved based on the beam related parameters of the two beams, so that the position of the target user device can be acquired in an analytical manner without the necessity of distinguishing the LOS path from the NLOS path, thereby improving the speed and accuracy of positioning.

### Second Embodiment

In a case that the target user device is a user device which is moving such as a vehicle, the transmitting end is required to determine an approximate direction of the transmitting beam according to an approximate position of the vehicle, so that the transmitted beam may be received by the target user device.

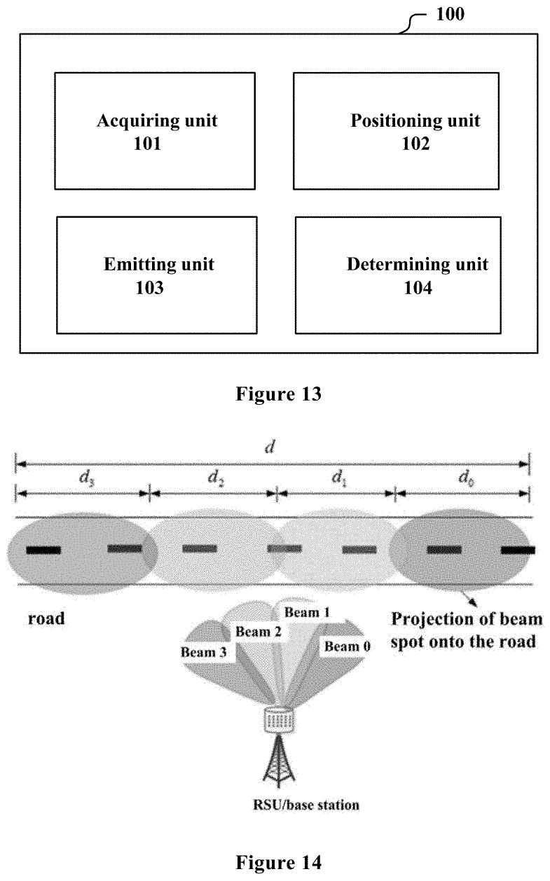

As shown in FIG. 13, the electronic apparatus 100 according to this embodiment may further include an emitting unit 103 and a determining unit 104. The electronic apparatus 100 may be located in an RSU or a base station. The emitting unit 103 is configured to emit a third beam to scan a predetermined region, and report feedback information to the electronic apparatus 100 for example through a low frequency band, in a case that the target user device exists in a predetermined region and receives the third beam signal. The feedback information includes, for example, a movement direction and a movement speed of the target user device. The acquiring unit 101 acquires the feedback information and provides the feedback information to the determining unit 104. A beam width of the third beam is greater than a beam width of the first beam (or the second beam). Therefore, in the following, the third beam is also referred to as a wide beam, and the first beam (or second beam) is referred to as a narrow beam. Further, the first beam is mainly described as an example of the narrow beam. It should be understood that the wide beam and the narrow beam described herein are a couple of relative concepts, and the specific numerical ranges thereof are not limited. The wide beam has a larger beam width and covers a larger region. The target user device can be quickly found by the wide beam scanning. The narrow beam has a small beam width and covers a small region, but has a high signal-to-noise ratio. Therefore, the narrow beam can be used to accurately estimate AOA information of a signal.

The determining unit 104 determines a direction of departure and duration of the narrow beam to be transmitted based on the feedback information acquired by the acquiring unit 101, so that the narrow beam can be received by the target user device. The emitting unit 103 emits the narrow beam according to the determined direction of departure and duration at predetermined timing.

FIG. 14 shows an example of wide beam scanning. FIG. 14 shows a section of d-meter-long road, which is divided into 4 parts of lengths d₀, d₁, d₂, and d₃ meters, respectively. The 4 parts are respectively covered by 4 wide beams. In order to scan the entire region, the RSU or the base station first generates a beam 0 to scan the road part with a length of d₀ meters. The road part is the predetermined region corresponding to the beam 0. In the next period, such as a time slot, the RSU or base station generates the beam 1 to scan the road part with a length of d₁ meters, and then generates beams 2 and 3 to scan the road parts with lengths d₂ and d₃ meters respectively. After the entire road is scanned, the RSU or base station generates the beam 0 again to start a next cycle.

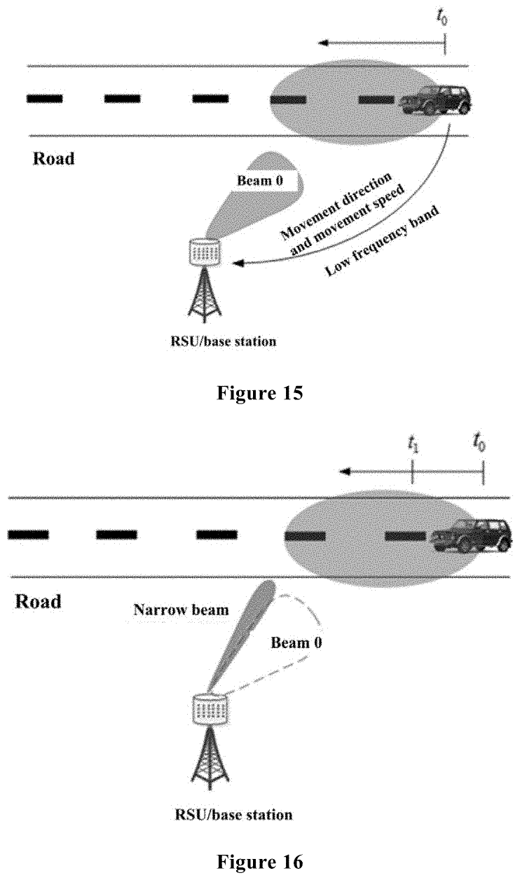

It is assumed that a vehicle serving as the target user device enters a road region with a length of d₀ meters at a time instant to and receives a signal of the beam 0. The vehicle reports its movement speed and movement direction to the corresponding RSU or base station through a low frequency band, as shown in FIG. 15. If the transmitting end of the wide beam is an RSU, the reported information is transmitted through sidelink. If the transmitting end of the wide beam is a base station, the reported information is transmitted through an uplink. In the example of FIG. 15, the movement direction may indicate the vehicle moving to the left or the right, for example, which is represented by 0 or 1. In the description of this embodiment, the vehicle serves as an example of the target user device, which is only for illustration and is not restrictive.

According to a movement speed v reported by the vehicle, the determining unit 104 calculates maximum possible travelling duration Δt of the vehicle in the region, as shown in the following equation (60).

$$Δ t = \frac{{d}_{0}}{v} \qquad ( 60 )$$

In the equation (60), Δt is a time period required for the vehicle to pass through an entire predetermined region at the reported movement speed. It is assumed that length of a time slot is tₛₗₒₜ, the emitting unit 103 may generate a narrow beam at a time instant t₁=t₀+tₛₗₒₜ. The narrow beam lasts until a time instant t₁+Δt to wait for the vehicle to receive a signal of the narrow beam. Alternatively, the duration of the narrow beam may be shorter than Δt.

In addition, the determining unit 104 determines a direction of departure of the narrow beam as an outer direction immediately adjacent to a side of the wide beam being consistent with the movement direction of the vehicle. That is, the narrow beam is directed to a front of the vehicle movement. As shown in FIG. 16, if the vehicle moves to the left, the narrow beam is directed to a direction adjacent to the left of the wide beam. If the vehicle moves to the right, the narrow beam is directed to a direction adjacent to the right of the wide beam.

In a case that the positioning method described in the first embodiment is adopted to perform positioning, the narrow beam may serve as the first beam. That is, an RSU or base station (referred to as a first RSU or a first base station) where the electronic apparatus 100 is located emits the first beam. Meanwhile, another RSU or base station (hereinafter referred to as a second RSU or a second base station) emits the second beam at the same timing. The first RSU or the first base station and the second RSU or the second base station may be designated by the positioning server, or designated automatically when a vehicle is scanned. Alternatively, the second RSU or the second base station may be designated by the first RSU or the first base station. Alternatively, the first RSU or the first base station and the second RSU or the second base station are fixed, which is not restrictive.

The direction of departure and duration of the second beam may be determined by the second RSU or the second base station in the same manner as described above. Alternatively, the electronic apparatus 100 on the first RSU or the first base station provides the determined direction of departure and duration of the first beam to the second RSU or the second base station, so that the second RSU or the second base station determines the direction of departure and duration of the second beam based on the direction of departure and duration of the first beam. Alternatively, the electronic apparatus 100 on the first RSU or the first base station determines the direction of departure of the second beam based on the direction of departure of the first beam and a positional relationship between the first RSU or the first base station and the second RSU or the second base station, and provides the direction of departure together with the duration to the second RSU or the second base station.

Upon receiving the first beam and the second beam, the vehicle acquires an AOA of the first beam and the information for estimating the distance it travels as well as an AOA of the second beam and the information for estimating the distance it travels, and provides the acquired information to the first RSU or the first base station. In addition, in a case that the direction of departure of the second beam is calculated by the second RSU or the second base station by itself, the second RSU or the second base station provides AOD information of the second beam to the first RSU or the first base station. Based on the above information, the first RSU or the first base station determines the position of the vehicle in the manner described in the first embodiment.

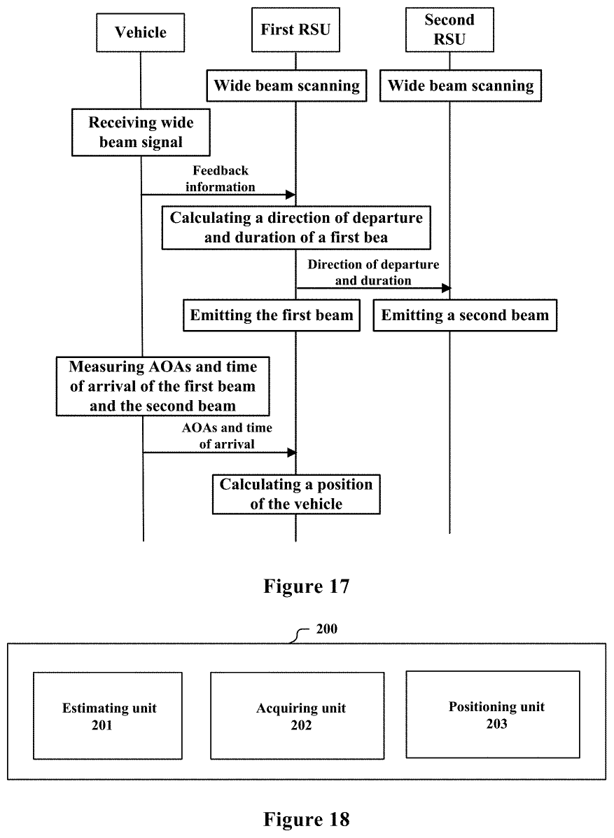

For ease of understanding, FIG. 17 is a schematic diagram showing an information procedure between RSUs and the vehicle in a positioning process according to this embodiment. First, the first RSU and the second RSU simultaneously perform wide beam scanning with respect to the same region. If no feedback information from a vehicle is received in a scanning cycle, the first RSU and the second RSU change the direction of departure of the wide beam and simultaneously scan another region. Next, if the vehicle receives a signal of the wide beam, the vehicle reports feedback information to the first RSU (referred to as a main RSU in this example). The feedback information includes, for example, a movement direction and a movement speed of the vehicle. The first RSU calculates a direction of departure and duration of the first beam based on the feedback information. In this example, the first RSU also calculates a direction of departure and duration of the second beam and provides the direction of departure and the duration of the second beam to the second RSU. Then, the first RSU and the second RSU respectively transmit the first beam and the second beam at the same timing. When receiving the first beam and the second beam, the vehicle measures an AOA and time of arrival of the first beam and an AOA and time of arrival of the second beam, and provides them to the first RSU. Since the AOD of the first beam and the AOD of the second beam are known to the first RSU, the position of the vehicle can be calculated in the analytical manner described in the first embodiment. It should be noted that the information procedure shown in FIG. 17 is only illustrative, and may be appropriately modified according to actual requirements.

The electronic apparatus 100 according to this embodiment can accurately and quickly determine the position of the target user device in travelling.

### Third Embodiment

FIG. 18 is a functional block diagram showing an electronic apparatus 200 for wireless communications according to another embodiment of the present disclosure. As shown in FIG. 8, the electronic apparatus 200 includes an estimating unit 201, an acquiring unit 202 and a positioning unit 203. The estimating unit 201 is configured to estimate beam related information of at least a first beam and a second beam which are received. The beam related information includes an angle of arrival of a beam and information for distance estimation. The acquiring unit 202 is configured to acquire information of AODs of at least the first beam and the second beam. The positioning unit 203 is configured to determine, at least based on the beam related information of the first beam and the second beam as well as the information of the AOD of the first beam and the AOD of the second beam, a position of the electronic apparatus 200.

The estimating unit 201, the acquiring unit 201, and the positioning unit 203 may be implemented by one or more processing circuitries, which may be implemented as, for example, chips or processors. In addition, it should be understood that functional units in the electronic apparatus shown in FIG. 18 are only logical modules divided based on their respective functions, and are not intended to limit a specific implementation manner.

The electronic apparatus 200 may, for example, be arranged on a side of a target user device to be positioned or be communicatively connected to the target user device. The target user device is, for example, a vehicle or other mobile communication terminal.

Here, it should further be noted that the electronic apparatus 200 may be implemented at a chip level, or a device level. For example, the electronic apparatus 200 may function as the target user device itself, and further include an external device such as a memory, a transceiver, and the like (not shown in the drawings). The memory is configured to store programs executed by the target user device to implement various functions and related data information. The transceiver may include one or more communication interfaces to support communication with various devices (for example, a base stations, an RSU, other target user device or the like.). An implementation manner of the transceiver is not particularly limited herein.

In this embodiment, the target user device receives a beam emitted by the base station or the RSU, such as the first beam and the second beam, measures the received beams to obtain at least two sets of beam related parameters, and acquires information of an AOD of the beam from the base station or RSU. The positioning unit 203 positions the electronic apparatus 100 (that is, the target user device where the electronic apparatus 100 is located) in the same manner as in the first embodiment, based on these beam related parameters and the acquired information of the AOD. Therefore, the positioning unit 203 has the same structure and function as the positioning unit 102 described in the first embodiment, and therefore is not described repeatedly here.

In addition, the estimating unit 201 estimates the AOA of the beam in various manners. For example, the estimating unit 201 generates a receiving beam and estimates the AOA based on an angle between a direction of the receiving beam and the reference direction. Alternatively, the estimating unit 201 estimates the AOA in a super-resolution manner such as multiple signal classification (MUSIC) method instead of generating a receiving beam.

The information for distance estimation may include information of the time of arrival of the beam or information of received power of the beam, which is specifically described in detail in the first embodiment and is not repeated here.

The acquiring unit 202 acquires the information of AODs of the first beam and the second beam through communication on a low frequency band, such as the FR1 frequency band in 5G communication, without forming a beam. Alternatively, the acquiring unit 202 acquires the information of AODs of the first beam and the second beam through communication on a high frequency band, such as the FR2 frequency band in 5G communication. In this case, the RSU or the base station may form an additional transmission beam, or may carry the information on the first beam or the second beam.

In summary, the electronic apparatus 200 according to this embodiment can position the target user device based on at least two beams, and can accurately determine the position of the electronic apparatus 200 in both cases of the presence and absence of an LOS path. The set of equations are solved based on the beam related parameters of the two beams, so that the position of the target user device can be acquired in an analytical manner without the necessity of distinguishing the LOS path from the NLOS path, thereby improving the speed and accuracy of positioning.

### Fourth Embodiment

In the above description of embodiments of the electronic apparatuses for wireless communications, it is apparent that some processing and methods are further disclosed. In the following, a summary of the methods are described without repeating details that are described above. However, it should be noted that although the methods are disclosed when describing the electronic apparatuses for wireless communications, the methods are unnecessary to adopt those components or to be performed by those components described above. For example, implementations of the electronic apparatuses for wireless communications may be partially or completely implemented by hardware and/or firmware. Methods for wireless communications to be discussed blow may be completely implemented by computer executable programs, although these methods may be implemented by the hardware and/or firmware for implementing the electronic apparatuses for wireless communications.

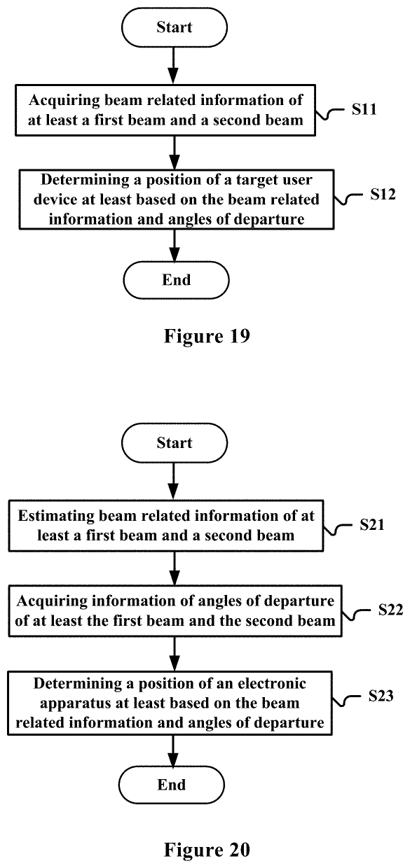

FIG. 19 is a flowchart showing a method for wireless communications according to an embodiment of the present disclosure. The method includes: acquiring beam related information of at least a first beam and a second beam estimated by a target user device (S11), the beam related information including an angle of arrival of a beam and information for distance estimation; and determining, at least based on the beam related information of the first beam and the second beam as well as an angle of departure of the first beam and an angle of departure of the second beam, a position of the target user device (S12). The method may be performed on a side of a base station or RSU, or on a side of a server functioning as a positioning server.

The angle of arrival of the beam may be expressed by an angle of a direction of arrival of the beam relative to a predetermined reference direction. The information for distance estimation includes information of time of arrival of the beam. In step S11, a travelling distance of the first beam from the transmitting end of the first beam to the target user device is estimated based on information of time of arrival of the first beam, and a travelling distance of the second beam from the transmitting end of the second beam to the target user device is estimated based on information of time of arrival of the second beam. Alternatively, the information for distance estimation may include information of received power of a beam. In step S11, a travelling distance of the first beam from the transmitting end of the first beam to the target user device is estimated based on information of received power of the first beam, and a travelling distance of the second beam from the transmitting end of the second beam to the target user device is estimated based on information of received power of the second beam.

For example, the first beam is emitted by a first RSU or a first base station, and the second beam is emitted by a second RSU or a second base station. The method further includes: acquiring the angle of departure of the first beam from the first RSU or the first base station, and acquiring the angle of departure of the second beam from the second RSU or the second base station. In the case that the above method is performed on the side of the first RSU or the first base station, it is only required to acquire the angle of departure of the second beam from the second RSU or the second base station.

In step S11, the beam related information of the first beam and the second beam may be acquired through communication on a low frequency band.

In step S12, the position of the target user device is determined based on a geometric relationship between actual propagation paths of the first beam and the second beam and a spatial position of the target user device. For example, the position of the target user device may be determined by determining absolute position coordinates of the target user device or relative coordinates of the target user device with respect to a predetermined reference object. In addition, in step S12, the position of the target user device can also be determined based on a minimum mean square error algorithm.

Although not shown in FIG. 19, the above method may further include the following steps: emitting a third beam to scan a predetermined region, where a beam width of the third beam is greater than a beam width of the first beam; acquiring feedback information from the target user device in a case that the target user device is in the predetermined region, where the feedback information includes a movement direction and a movement speed of the target user device; determining a direction of departure and duration of the first beam based on the feedback information, so that the first beam can be received by the target user device; and emitting the first beam according to the determined direction of departure and duration at predetermined timing.

The direction of departure of the first beam may be determined as an outer direction immediately adjacent to a side of the third beam being consistent with the movement direction of the target user device. The duration of the first beam is determined to be equal to or less than a time period required for the target user device to pass through the predetermined region at the movement speed.

The second road side unit or the second base station emits a third beam to scan the predetermined region. The above method further includes: providing the determined direction of departure and duration of the first beam to the second road side unit or the second base station, so that the second road side unit or the second base station determines a direction of departure and duration of the second beam based on the direction of departure and the duration of the first beam, and emits the second beam at the same timing. The target user device in this embodiment may be a vehicle.

FIG. 20 is a flowchart showing a method for wireless communications according to another embodiment of the present disclosure. The method includes: estimating beam related information of at least a first beam and a second beam received (S21), the beam related information including an angle of arrival of a beam and information for distance estimation; acquiring information of angles of departure of at least the first beam and the second beam (S22); and determining, at least based on the beam related information of the first beam and the second beam as well as information of an angle of departure of the first beam and an angle of departure of the second beam, a position of the electronic apparatus (S23). This method may be performed on a side of the target user device, for example.

It should be noted that the above methods may be performed in combination or separately. Details of the above methods are described in the first to the third embodiments, and are not repeated herein.

The technology of the present disclosure may be applied to various products.

For example, the electronic apparatus 100 may be implemented as various base stations. The base station may be implemented as any type of evolved node B (eNB) or gNB (5G base station). The eNB includes, for example, a macro eNB and a small eNB. The small eNB may be an eNB covering a cell smaller than a macro cell, such as a pico eNB, a micro eNB, and a home (femto) eNB. The case for the gNB is similar to the above. Alternatively, the base station may be implemented as any other type of base station, such as a NodeB and a base transceiver station (BTS). The base station may include: a main body (also referred to as a base station apparatus) configured to control wireless communication; and one or more remote wireless head ends (RRH) located at positions different from the main body. In addition, various types of user equipment may each serves as a base station by performing functions of the base station temporarily or semi-permanently.

The electronic apparatus 200 may be implemented as various user devices. The user device may be implemented as a mobile terminal (such as a smartphone, a tablet personal computer (PC), a notebook PC, a portable game terminal, a portable/dongle mobile router, and a digital camera device) or an in-vehicle terminal such as a car navigation apparatus. The user device may also be implemented as a terminal (also referred to as a machine type communication (MTC) terminal) that performs machine-to-machine (M2M) communication. In addition, the user device may be a wireless communication module (such as an integrated circuit module including a single chip) mounted on each of the terminals described above.

### Application Example Regarding a Base Station

### First Application Example

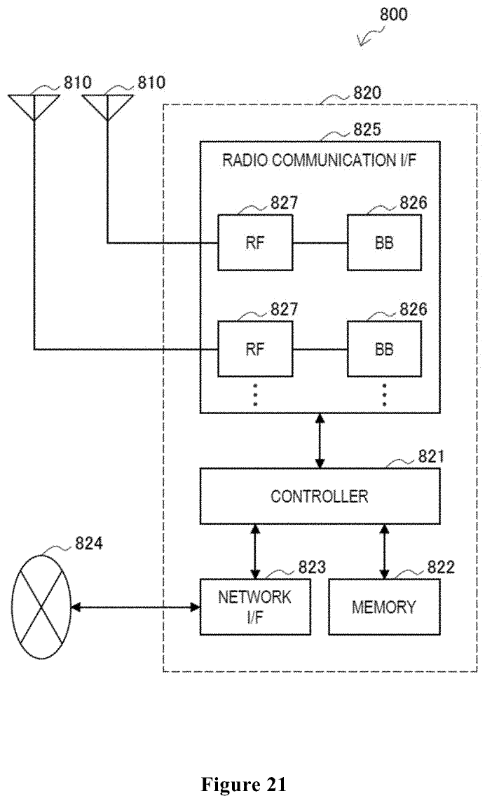

FIG. 21 is a block diagram showing a first example of a schematic configuration of an eNB or a gNB to which the technology according to the present disclosure may be applied. It should be noted that the following description is given by taking the eNB as an example, which is also applicable to the gNB. An eNB 800 includes one or more antennas 810 and a base station apparatus 820. The base station apparatus 820 and each of the antennas 810 may be connected to each other via an RF cable.

Each of the antennas 810 includes a single antennal element or multiple antennal elements (such as multiple antenna elements included in a multiple-input multiple-output (MIMO) antenna), and is used for the base station apparatus 820 to transmit and receive wireless signals. As shown in FIG. 21, the eNB 800 may include the multiple antennas 810. For example, the multiple antennas 810 may be compatible with multiple frequency bands used by the eNB 800. Although FIG. 21 shows the example in which the eNB 800 includes the multiple antennas 810, the eNB 800 may also include a single antenna 810.

The base station apparatus 820 includes a controller 821, a memory 822, a network interface 823, and a radio communication interface 825.

The controller 821 may be, for example, a CPU or a DSP, and operates various functions of a higher layer of the base station apparatus 820. For example, the controller 821 generates a data packet from data in signals processed by the radio communication interface 825, and transfers the generated packet via the network interface 823. The controller 821 may bundle data from multiple base band processors to generate the bundled packet, and transfer the generated bundled packet. The controller 821 may have logical functions of performing control such as radio resource control, radio bearer control, mobility management, admission control and scheduling. The control may be performed in corporation with an eNB or a core network node in the vicinity. The memory 822 includes a RAM and a ROM, and stores a program executed by the controller 821 and various types of control data (such as a terminal list, transmission power data and scheduling data).

The network interface 823 is a communication interface for connecting the base station apparatus 820 to a core network 824. The controller 821 may communicate with a core network node or another eNB via the network interface 823. In this case, the eNB 800, and the core network node or another eNB may be connected to each other via a logic interface (such as an S1 interface and an X2 interface). The network interface 823 may also be a wired communication interface or a wireless communication interface for wireless backhaul. If the network interface 823 is a wireless communication interface, the network interface 823 may use a higher frequency band for wireless communication than that used by the radio communication interface 825.

The radio communication interface 825 supports any cellular communication scheme (such as Long Term Evolution (LTE) and LTE-advanced), and provides wireless connection to a terminal located in a cell of the eNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and performs various types of signal processing of layers (such as L1, Media Access Control (MAC), Radio Link Control (RLC), and a Packet Data Convergence Protocol (PDCP)). The BB processor 826 may have a part or all of the above-described logical functions instead of the controller 821. The BB processor 826 may be a memory storing communication control programs, or a module including a processor and a related circuit configured to execute the programs. Updating the program may allow the functions of the BB processor 826 to be changed. The module may be a card or a blade that is inserted into a slot of the base station apparatus 820. Alternatively, the module may also be a chip that is mounted on the card or the blade. Further, the RF circuit 827 may include, for example, a mixer, a filter, and an amplifier, and transmits and receives wireless signals via the antenna 810.

As show in FIG. 21, the radio communication interface 825 may include the multiple BB processors 826. For example, the multiple BB processors 826 may be compatible with multiple frequency bands used by the eNB 800. The radio communication interface 825 may include multiple RF circuits 827, as shown in FIG. 21. For example, the multiple RF circuits 827 may be compatible with multiple antenna elements. Although FIG. 21 shows the example in which the radio communication interface 825 includes the multiple BB processors 826 and the multiple RF circuits 827, the radio communication interface 825 may also include a single BB processor 826 and a single RF circuit 827.

In the eNB 800 shown in FIG. 21, the transceiver of the electronic apparatus 100 may be implemented by the radio communication interface 825. At least a part of the functions may also be implemented by the controller 821. For example, the controller 821 may accurately and quickly determine the position of the target user device by performing the functions of the acquiring unit 101 and the positioning unit 102.

### Second Application Example

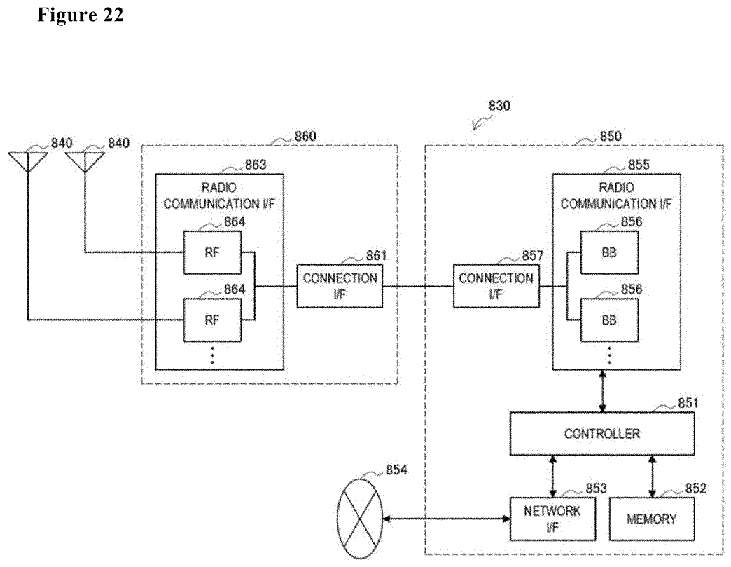

FIG. 22 is a block diagram showing a second example of a schematic configuration of an eNB or a gNB to which the technology according to the present disclosure may be applied. It should be noted that the following description is given by taking the eNB as an example, which is also applied to the gNB. An eNB 830 includes one or more antennas 840, a base station apparatus 850, and an RRH 860. The RRH 860 and each of the antennas 840 may be connected to each other via an RF cable. The base station apparatus 850 and the RRH 860 may be connected to each other via a high speed line such as an optical fiber cable.

Each of the antennas 840 includes a single or multiple antennal elements (such as multiple antenna elements included in an MIMO antenna), and is used for the RRH 860 to transmit and receive wireless signals. As shown in FIG. 22, the eNB 830 may include the multiple antennas 840. For example, the multiple antennas 840 may be compatible with multiple frequency bands used by the eNB 830. Although FIG. 22 shows the example in which the eNB 830 includes the multiple antennas 840, the eNB 830 may also include a single antenna 840.

The base station apparatus 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 21.

The radio communication interface 855 supports any cellular communication scheme (such as LTE and LTE-advanced), and provides wireless communication to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 21, except that the BB processor 856 is connected to an RF circuit 864 of the RRH 860 via the connection interface 857. As show in FIG. 22, the radio communication interface 855 may include multiple BB processors 856. For example, the multiple BB processors 856 may be compatible with multiple frequency bands used by the eNB 830. Although FIG. 22 shows the example in which the radio communication interface 855 includes the multiple BB processors 856, the radio communication interface 855 may also include a single BB processor 856.

The connection interface 857 is an interface for connecting the base station apparatus 850 (radio communication interface 855) to the RRH 860. The connection interface 857 may also be a communication module for communication in the above-described high speed line that connects the base station apparatus 850 (radio communication interface 855) to the RRH 860.

The RRH 860 includes a connection interface 861 and a radio communication interface 863.

The connection interface 861 is an interface for connecting the RRH 860 (radio communication interface 863) to the base station apparatus 850. The connection interface 861 may also be a communication module for communication in the above-described high speed line.

The radio communication interface 863 transmits and receives wireless signals via the antenna 840. The radio communication interface 863 may typically include, for example, an RF circuit 864. The RF circuit 864 may include, for example, a mixer, a filter and an amplifier, and transmits and receives wireless signals via the antenna 840. The radio communication interface 863 may include multiple RF circuits 864, as shown in FIG. 22. For example, the multiple RF circuits 864 may support multiple antenna elements. Although FIG. 22 shows the example in which the radio communication interface 863 includes the multiple RF circuits 864, the radio communication interface 863 may also include a single RF circuit 864.

In the eNB 830 shown in FIG. 22, the transceiver of the electronic apparatus 100 may be implemented by the radio communication interface 825. At least a part of the functions may also be implemented by the controller 821. For example, the controller 821 may accurately and quickly determine the position of the target user device by performing the functions of the acquiring unit 101 and the positioning unit 102.

### Application Example Regarding a User Device

### First Application Example

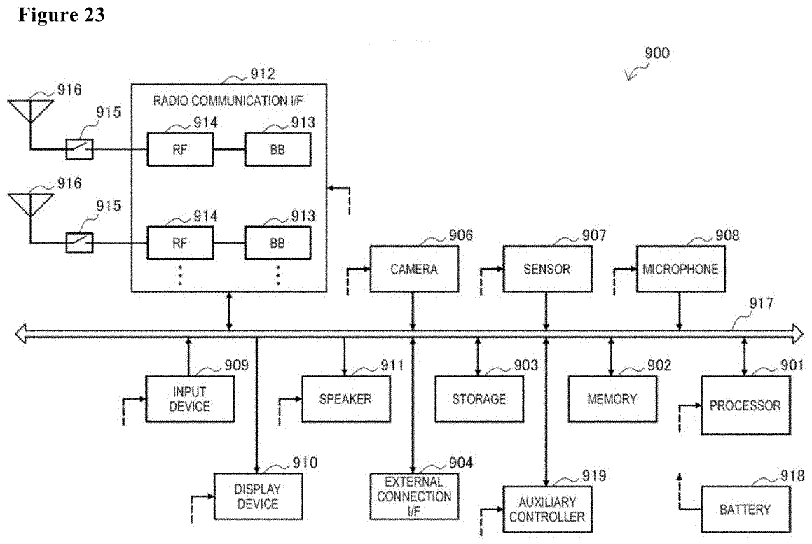

FIG. 23 is a block diagram illustrating an example of a schematic configuration of a smartphone 900 to which the technology according to the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and another layer of the smartphone 900. The memory 902 includes a RAM and a ROM, and stores a program executed by the processor 901 and data. The storage 903 may include a storage medium such as a semiconductor memory and a hard disk. The external connection interface 904 is an interface for connecting an external device (such as a memory card and a universal serial bus (USB) device) to the smartphone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetism sensor, and an acceleration sensor. The microphone 908 converts sounds that are inputted to the smartphone 900 into audio signals. The input device 909 includes, for example, a touch sensor configured to detect touch onto a screen of the display device 910, a keypad, a keyboard, a button, or a switch, and receives an operation or information inputted from a user. The display device 910 includes a screen (such as a liquid crystal display (LCD) and an organic light-emitting diode (OLED) display), and displays an output image of the smartphone 900. The speaker 911 converts audio signals that are outputted from the smartphone 900 into sounds.

The radio communication interface 912 supports any cellular communication scheme (such as LTE and LTE-advanced), and performs wireless communication. The radio communication interface 912 may include, for example, a BB processor 913 and an RF circuit 914. The BB processor 913 may perform, for example, encoding/decoding, modulating/demodulating, and multiplexing/de-multiplexing, and perform various types of signal processing for wireless communications. The RF circuit 914 may include, for example, a mixer, a filter and an amplifier, and transmits and receives wireless signals via the antenna 916. It should be noted that although FIG. 23 shows a case that one RF link is connected to one antenna, which is only illustrative, and a case that one RF link is connected to multiple antennas through multiple phase shifters may also exist. The radio communication interface 912 may be a chip module having the BB processor 913 and the RF circuit 914 integrated thereon. The radio communication interface 912 may include multiple BB processors 913 and multiple RF circuits 914, as shown in FIG. 23. Although FIG. 23 shows the example in which the radio communication interface 912 includes the multiple BB processors 913 and the multiple RF circuits 914, the radio communication interface 912 may also include a single BB processor 913 or a single RF circuit 914.

Furthermore, in addition to a cellular communication scheme, the radio communication interface 912 may support another type of wireless communication scheme such as a short-distance wireless communication scheme, a near field communication scheme, and a radio local area network (LAN) scheme. In this case, the radio communication interface 912 may include the BB processor 913 and the RF circuit 914 for each wireless communication scheme.

Each of the antenna switches 915 switches connection destinations of the antennas 916 among multiple circuits (such as circuits for different wireless communication schemes) included in the radio communication interface 912.

Each of the antennas 916 includes a single or multiple antenna elements (such as multiple antenna elements included in an MIMO antenna) and is used for the radio communication interface 912 to transmit and receive wireless signals. The smartphone 900 may include multiple antennas 916, as shown in FIG. 23. Although FIG. 23 shows the example in which the smartphone 900 includes the multiple antennas 916, the smartphone 900 may also include a single antenna 916.

Furthermore, the smartphone 900 may include the antenna 916 for each wireless communication scheme. In this case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smart phone 900 shown in FIG. 23 via feeder lines that are partially shown as dashed lines in FIG. 23. The auxiliary controller 919 operates a minimum necessary function of the smartphone 900, for example, in a sleep mode.

In the smartphone 900 shown in FIG. 23, the transceiver of the electronic apparatus 200 may be implemented by the radio communication interface 912. At least a part of the functions may also be implemented by the processor 901 or the auxiliary controller 919. For example, the processor 901 or the auxiliary controller 919 can quickly and accurately determine the position of the target user device where the electronic apparatus 200 is located by performing functions of the estimating unit 201, the acquiring unit 202, and the positioning unit 203.

### Second Application Example

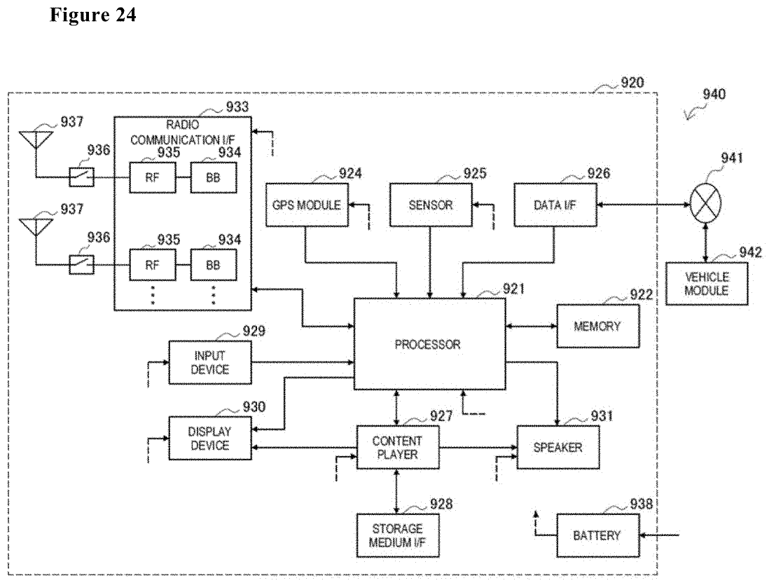

FIG. 24 is a block diagram showing an example of a schematic configuration of a car navigation device 920 to which the technology according to the present disclosure may be applied. The car navigation apparatus 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example a CPU or a SoC, and controls a navigation function and additional function of the car navigation apparatus 920. The memory 922 includes a RAM and a ROM, and stores a program that is executed by the processor 921, and data.

The GPS module 924 determines a position (such as latitude, longitude and altitude) of the car navigation apparatus 920 by using GPS signals received from a GPS satellite. The sensor 925 may include a group of sensors such as a gyro sensor, a geomagnetic sensor and an air pressure sensor. The data interface 926 is connected to, for example, an in-vehicle network 941 via a terminal that is not shown, and acquires data (such as vehicle speed data) generated by the vehicle.

The content player 927 reproduces content stored in a storage medium (such as a CD and a DVD) that is inserted into the storage medium interface 928. The input device 929 includes, for example, a touch sensor configured to detect touch onto a screen of the display device 930, a button, or a switch, and receives an operation or information inputted from a user. The display device 930 includes a screen such as an LCD or OLED display, and displays an image of the navigation function or content that is reproduced. The speaker 931 outputs sounds for the navigation function or the content that is reproduced.

The radio communication interface 933 supports any cellular communication scheme (such as LTE and LTE-Advanced), and performs wireless communications. The radio communication interface 933 may typically include, for example, a BB processor 934 and an RF circuit 935. The BB processor 934 may perform, for example, encoding/decoding, modulating/demodulating and multiplexing/demultiplexing, and perform various types of signal processing for wireless communications. The RF circuit 935 may include, for example, a mixer, a filter and an amplifier, and transmits and receives wireless signals via the antenna 937. The radio communication interface 933 may also be a chip module having the BB processor 934 and the RF circuit 935 integrated thereon. The radio communication interface 933 may include multiple BB processors 934 and multiple RF circuits 935, as shown in FIG. 24. Although FIG. 24 shows the example in which the radio communication interface 933 includes the multiple BB processors 934 and the multiple RF circuits 935, the radio communication interface 933 may also include a single BB processor 934 and a single RF circuit 935.

Furthermore, in addition to the cellular communication scheme, the radio communication interface 933 may support another type of wireless communication scheme such as a short-distance wireless communication scheme, a near field communication scheme, and a wireless LAN scheme. In this case, the radio communication interface 933 may include the BB processor 934 and the RF circuit 935 for each wireless communication scheme.

Each of the antenna switches 936 switches connection destinations of the antennas 937 among multiple circuits (such as circuits for different wireless communication schemes) included in the radio communication interface 933.

Each of the antennas 937 includes a single or multiple antenna elements (such as multiple antenna elements included in an MIMO antenna), and is used for the radio communication interface 933 to transmit and receive wireless signals. As shown in FIG. 24, the car navigation apparatus 920 may include multiple antennas 937. Although FIG. 24 shows the example in which the car navigation apparatus 920 includes the multiple antennas 937, the car navigation apparatus 920 may also include a single antenna 937.

Furthermore, the car navigation apparatus 920 may include the antenna 937 for each wireless communication scheme. In this case, the antenna switches 936 may be omitted from the configuration of the car navigation apparatus 920.

The battery 938 supplies power to the blocks of the car navigation apparatus 920 shown in FIG. 24 via feeder lines that are partially shown as dash lines in FIG. 24. The battery 938 accumulates power supplied from the vehicle.

In the car navigation apparatus 920 shown in FIG. 24, the transceiver of the electronic apparatus 100 may be implemented by the radio communication interface 912. At least a part of the functions may be implemented by the processor 901 or the auxiliary controller 919. For example, the processor 901 or the auxiliary controller 919 can quickly and accurately determine the position of the target user device where the electronic apparatus 200 is located by performing functions of the estimating unit 201, the acquiring unit 202, and the positioning unit 203.

The technology of the present disclosure may also be implemented as an in-vehicle system (or a vehicle) 940 including one or more blocks of the car navigation apparatus 920, the in-vehicle network 941 and a vehicle module 942. The vehicle module 942 generates vehicle data (such as a vehicle speed, an engine speed, and failure information), and outputs the generated data to the in-vehicle network 941.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

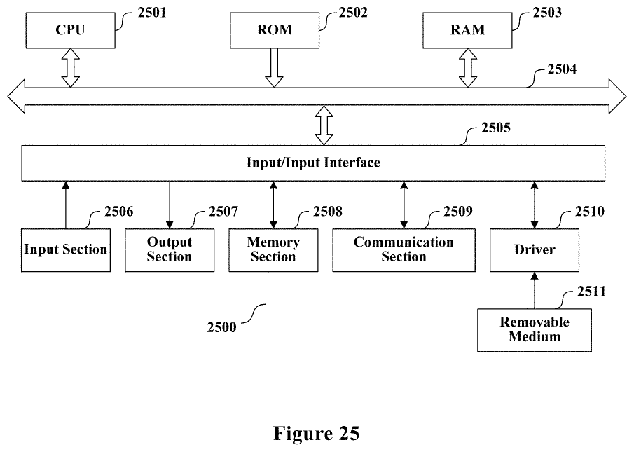

In the case where the present disclosure is realized with software or firmware, a program constituting the software is installed in a computer with a dedicated hardware structure (e.g. the general computer 2500 shown in FIG. 25) from a storage medium or network, wherein the computer is capable of implementing various functions when installed with various programs.

In FIG. 25, a central processing unit (CPU) 2501 executes various processing according to a program stored in a read-only memory (ROM) 2502 or a program loaded to a random access memory (RAM) 2503 from a memory section 2508. The data needed for the various processing of the CPU 2501 may be stored in the RAM 2503 as needed. The CPU 2501, the ROM 2502 and the RAM 2503 are linked with each other via a bus 2504. An input/output interface 2505 is also linked to the bus 2504.

The following components are linked to the input/output interface 2505: an input section 2506 (including keyboard, mouse and the like), an output section 2507 (including displays such as a cathode ray tube (CRT), a liquid crystal display (LCD), a loudspeaker and the like), a memory section 2508 (including hard disc and the like), and a communication section 2509 (including a network interface card such as a LAN card, modem and the like). The communication section 2509 performs communication processing via a network such as the Internet. A driver 2510 may also be linked to the input/output interface 2505, if needed. If needed, a removable medium 2511, for example, a magnetic disc, an optical disc, a magnetic optical disc, a semiconductor memory and the like, may be installed in the driver 2510, so that the computer program read therefrom is installed in the memory section 2508 as appropriate.

In the case where the foregoing series of processing is achieved through software, programs forming the software are installed from a network such as the Internet or a memory medium such as the removable medium 2511.

It should be appreciated by those skilled in the art that the memory medium is not limited to the removable medium 2511 shown in FIG. 25, which has program stored therein and is distributed separately from the apparatus so as to provide the programs to users. The removable medium 2511 may be, for example, a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Alternatively, the memory medium may be the hard discs included in ROM 2502 and the memory section 2508 in which programs are stored, and can be distributed to users along with the device in which they are incorporated.

To be further noted, in the apparatus, method and system according to the present disclosure, the respective components or steps can be decomposed and/or recombined. These decompositions and/or recombinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for wireless communications, comprising:
processing circuitry, configured to:
acquire beam related information of at least a first beam and a second beam estimated by a target user device, the beam related information comprising an angle of arrival of a beam and information for distance estimation; and
determine, at least based on the beam related information of the first beam and the second beam as well as an angle of departure of the first beam and an angle of departure of the second beam, a position of the target user device.

2. The electronic apparatus according to claim 1, wherein the processing circuitry is configured to determine the position of the target user device using a geometric relationship between actual propagation paths of the first beam and the second beam and a spatial position of the target user device.

3. The electronic apparatus according to claim 1, wherein the processing circuitry is configured to determine the position of the target user device using a minimum mean square error algorithm.

4. The electronic apparatus according to claim 1, wherein the information for distance estimation comprises information of time of arrival of a beam, and the processing circuitry is configured to estimate, based on the information of time of arrival of the first beam, a travelling distance of the first beam from a transmitting end of the first beam to the target user device, and estimate, based on the information of time of arrival of the second beam, a travelling distance of the second beam from a transmitting end of the second beam to the target user device.

5. The electronic apparatus according to claim 1, wherein the information for distance estimation comprises information of received power of a beam, and the processing circuitry is configured to estimate, based on information of received power of the first beam, a travelling distance of the first beam from a transmitting end of the first beam to the target user device, and estimate, based on information of received power of the second beam, a travelling distance of the second beam from a transmitting end of the second beam to the target user device.

6. The electronic apparatus according to claim 1, wherein the first beam is emitted by a first road side unit or a first base station, and the second beam is emitted by a second road side unit or a second base station.

7. The electronic apparatus according to claim 6, wherein the processing circuitry is configured to acquire the angle of departure of the first beam from the first road side unit or the first base station, and acquire the angle of departure of the second beam from the second road side unit or the second base station.

8. The electronic apparatus according to claim 6, wherein the electronic apparatus is located on a side of the first road side unit or the first base station, and the processing circuitry is configured to acquire the angle of departure of the second beam from the second road side unit or the second base station.

9. The electronic apparatus according to claim 8, wherein the processing circuitry is further configured to:
emit a third beam to scan a predetermined region, wherein a beam width of the third beam is larger than a beam width of the first beam;
in a case that the target user device exists in the predetermined region, acquire feedback information from the target user device, the feedback information comprising a movement direction and a movement speed of the target user device;
determine, based on the feedback information, a direction of departure and duration of the first beam, so that the first beam is capable of being received by the target user device; and
emit the first beam at a predetermined timing in accordance with the determined direction of departure and duration.

10. The electronic apparatus according to claim 9, wherein the processing circuitry is configured to determine the direction of departure of the first beam as an outer direction immediately adjacent to a side of the third beam being consistent with the movement direction of the target user device, and determine the duration of the first beam to be equal to or less than a time period required for the target user device to pass through the predetermined region at the movement speed.

11. The electronic apparatus according to claim 9, wherein the second road side unit or the second base station emits the third beam at the same time to scan the predetermined region.

12. The electronic apparatus according to claim 9, wherein the processing circuitry is configured to provide the determined direction of departure and duration of the first beam to the second road side unit or the second base station, so that the second road side unit or the second base station is configured to determine a direction of departure and duration of the second beam based on the direction of departure and the duration of the first beam, and emit the second beam at the same timing.

13. The electronic apparatus according to claim 1, wherein the processing circuitry is configured to acquire the beam related information of the first beam and the second beam through communication on a low frequency band.

14. The electronic apparatus according to claim 1, wherein the processing circuitry is configured to determine the position of the target user device by determining relative coordinates of the target user device with respect to a predetermined reference object or absolute position coordinates of the target user device.

15. The electronic apparatus according to claim 1, wherein an angle of arrival of a beam is expressed by an angle of a direction of arrival of the beam relative to a predetermined reference direction.

16.-18. (canceled)

19. An electronic apparatus for wireless communications, comprising:
processing circuitry, configured to:
estimate beam related information of at least a first beam and a second beam which are received, the beam related information comprising an angle of arrival of a beam and information for distance estimation;
acquire information of angles of departure of at least the first beam and the second beam; and
determine, at least based on the beam related information of the first beam and the second beam as well as the information of angles of departure of the first beam and the second beam, a position of the electronic apparatus.

20. The electronic apparatus according to claim 19, wherein the information for distance estimation comprises information of time of arrival of a beam or information of received power of a beam.

21. The electronic apparatus according to claim 19, wherein the processing circuitry is configured to determine the position of the electronic apparatus using a geometric relationship between actual propagation paths of the first beam and the second beam and a spatial position of the electronic apparatus.

22. The electronic apparatus according to claim 19, wherein the processing circuitry is configured to determine the position of the electronic apparatus using a minimum mean square error algorithm.

23. A method for wireless communications, comprising:
acquiring beam related information of at least a first beam and a second beam estimated by a target user device, the beam related information comprising an angle of arrival of a beam and information for distance estimation; and
determining, at least based on the beam related information of the first beam and the second beam as well as an angle of departure of the first beam and an angle of departure of the second beam, a position of the target user device.

24.-25. (canceled)
